(19) United States
(12) Patent Application Publication
(10) Pub. No.: US 2024/0225031 A9
(43) Pub. Date: Jul. 11, 2024

(54) METHOD OF ROASTING COFFEE BEANS

(71) Applicant: Koninklijke Douwe Egberts B.V., Utrecht (NL)

(72) Inventors: Thomas Imison, Hurley (GB); Joe Kirkup, Hurley (GB); Ria Brust, Utrecht (NL)

(21) Appl. No.: 18/269,170

(22) PCT Filed: Dec. 21, 2021
(86) PCT No.: PCT/EP2021/087014

§ 371 Date: Jun. 22, 2023

(30) Foreign Application Priority Data
Dec. 31, 2020 (GB) 2020807.0

(51) Int. Cl. A23F 5/04

(52) U.S. Cl. CPC A23F 5/04

(57) ABSTRACT

The invention provides a process of roasting whole coffee beans comprising a roasting stage starting at a temperature of the beans of around 200° C., characterised in that the process comprises the step of heating said whole coffee beans such that the temperature of said beans rises from a temperature of around 200 to around 230° C. at a rate of at least around 25° C./minute.

### TECHNICAL FIELD OF THE INVENTION

The invention relates to a method of roasting coffee beans, and coffee beans produced by such methods.

### BACKGROUND TO THE INVENTION

The process of roasting unroasted or “green” coffee beans can be divided into three stages: the first stage being the drying stage, the second stage being the Maillard reactions and Strecker degradation stage and the third stage being the caramelisation and pyrolysis stage. The point at which these stages start and end is not precisely defined, however, the ranges of average temperatures reached by the coffee beans in the roasting chamber at each stage are recognised in the prior art and summarised in the following paragraphs.

### The First Roasting Stage

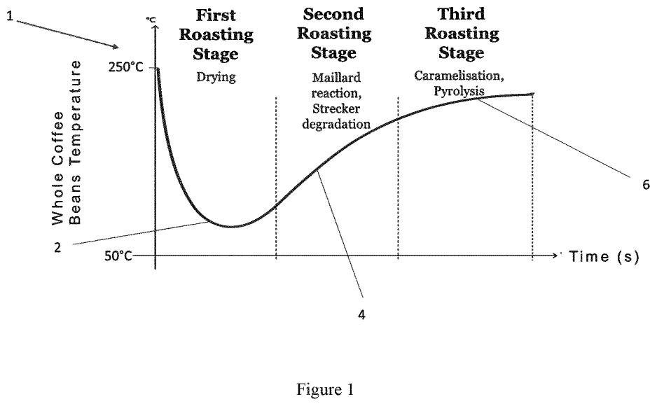

This is the so-called drying phase. This stage takes place whilst the whole unroasted coffee beans are being heated inside the roasting device up to a temperature of around 170° C. During this stage of the roasting process the water within the beans evaporates through an endothermic process, and the temperature within the roasting chamber drops as thermal energy is transferred to the cold beans, before the measured temperature in the roasting chamber increases again (as shown in FIG. 1). Due to the development of gases (mainly carbon dioxide and steam) an increase in the volume (/size) of the coffee beans can be observed.

### The Second Roasting Stage

This stage takes place when the temperature of the whole coffee beans in the roasting chamber is between around 170 and around 200° C. The volume (/size) of the coffee beans continues to increase up to a point where the so-called “first crack” is observable, i.e., the internal pressure within the coffee bean builds up and it is released through a ‘crack’ of the bean structure. At this stage browning of the coffee beans is observable together with the beginning of flavour formation due to the development of Volatile Organic Compounds (VOCs). The coffee beans start to exhibit the characteristic aroma complexity of roasted coffee.

### The Third Roasting Stage

The third stage takes place when the temperature of the beans in the roasting chamber reaches above around 200° C. At this stage caramelisation and pyrolysis reactions occur within the coffee beans. Carbon monoxide is released from the coffee beans and the porous structure of the beans is further developed. This stage generally lasts until at least around 230° C. and often up to 250° C. and beyond, depending on the degree of roast required.

It should be noted that the terms “first”, “second” and “third” relate to the order of those stages only, and there may be further stages before the first and/or after the third, in some embodiments.

It is well recognised in the art of coffee beans roasting that some conventional roasting processes, particularly prolonged roasting processes, can result in the loss and/or degradation of important nutritional and/or sensorial compounds, such as for instance antioxidant compounds, polyphenols, chlorogenic acids etc. In particular, during the third stage of roasting, antioxidants can be lost relatively quickly.

The identification of roasting conditions which allow a balance between enhancing the content of nutritional compounds and at the same time the in-cup taste of a coffee beverage has not yet been identified in the state of the art.

It would be therefore advantageous to provide a method to manipulate, reduce or slow-down the oxidative processes within the roasted coffee beans.

Furthermore, it would be advantageous to provide a method of roasting whole coffee beans which results in an enhanced in-cup antioxidant activity.

In addition, it would be advantageous to provide a method of roasting whole coffee beans which allows an increase in the antioxidant activity of roasted coffee beans with a high roasting degree.

Finally, it would be advantageous to provide an easier and less expensive method to manipulate the roasting profile of coffee beans through a simple process conditions change.

It is therefore an aim of embodiments of the invention to overcome or mitigate at least one problem of the prior art whether disclosed herein or not.

### SUMMARY OF THE INVENTION

According to a first aspect of the invention there is provided a process of roasting whole coffee beans comprising a roasting stage starting at a temperature of the beans of around 200° C., characterised in that the process comprises the step of heating said whole coffee beans such that the temperature of said beans rises from a temperature of around 200° C. to around at least 230° C. at a rate of around at least 25° C./minute.

The heating step may comprise heating the whole coffee beans such that the temperature of the beans rises from a temperature of around 200° C. to around 250° C. or to the highest roast temperature of the process (or end of roast temperature), at a rate of around at least 25° C./minute

Preferably the coffee beans at the start of the process are unroasted or green coffee beans (which are then heated and roasted to around 200° C. before the heating/roasting step described above for the first aspect of the invention).

The inventors have found that a roasting stage starting at around 200° C. (caramelisation and pyrolysis stage) in which the temperature of the beans is raised from an initial temperature of around 200° C. to a temperature of at least around 230° C., at a rate of less than around 25° C./minute as provided by conventional roasting processes, results in roasted coffee beans with reduced or limited antioxidants. Conversely, the inventors have also surprisingly found that a faster caramelisation and pyrolysis phase of the roasting process (third roasting stage), in which the temperature of the beans is raised from an initial temperature of around 200° C. to a temperature of at least around 230° C., preferably to at least 250° C. or to the highest roast temperature or end of roast temperature, at a rate of at least around 25° C./minute leads instead a to an increased stability of phenolic radicals, reducing the potential for reactive oxygen species (ROS) to induce oxidative stress.

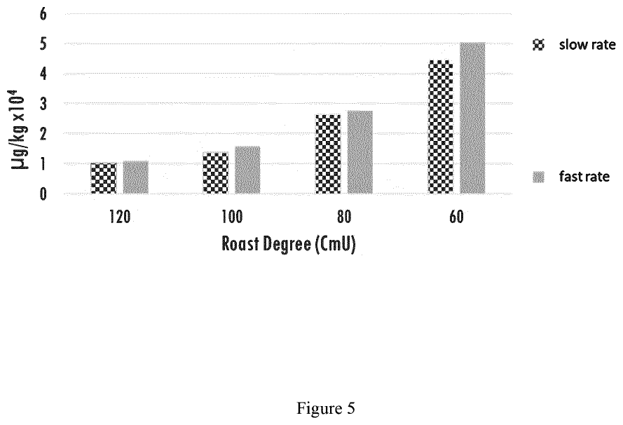

Without being bound by any theory, it is believed that manipulating the roasting profile gradient (° C./minute) in the temperature range between around 200° C. and around at least 230° C., as described the first aspect of the invention, may produce an increased proportion and amount of phenolic compounds with diene functional groups bonded off the aromatic rings (also known as diene functionalisation). This may increase the overall ability of the coffee phenolics ingested by a consumer to inhibit reactive oxygen species (ROS) from generating oxidative stress, and therefore help to prevent cell damage. This aspect becomes more significant with increasing roasting degree (as shown in FIG. 5).

Therefore, increasing the proportion of the phenolic compounds with diene functional groups bonded off the aromatic rings in the overall phenolic production during the roasting process is desirable.

The inventors have also found that through a manipulation of the time-temperature profile during the third roasting stage (e.g., from 200° C. up to at least 230° C.) a measurable effect on the antioxidant activity of the resulting whole coffee beans is found, resulting in an improved antioxidant activity of the derivable coffee brew.

In some embodiments the step of heating said coffee beans such that the temperature of said beans rises from a temperature of around 200° C. to at least around 230° C. is at a rate of at least 30° C./minute, at least 35° C./minute, at least 40° C./minute, at least 45° C./minute or at least 50° C./minute. In some embodiments the heating is at a rate of around 30-60° C./minute, preferably around 32-45° C./minute more preferably at a rate of around 33-40° C./minute, an even more preferably around 33-35° C./minute.

In some embodiments the process may comprise removing moisture from the coffee beans to no more than 5% wt., 3% wt., 2.5% wt., 2% wt., 1.75% wt., 1.5% wt., or no more than 1% wt.

In some embodiments the process comprises three stages of roasting, a first stage of roasting which raises the temperature of the beans from around 80° C. to around 170° C.; a second stage of roasting which raises the temperature of the beans from around 170° C. to around 200° C.; and said (third) stage of roasting which raises the temperature of the beans from 200° C. to at least 230° C. and preferably the highest roast temperature or end of roast temperature, at a rate of at least around 25° C./minute, preferably around 30-60° C./minute. It will be understood by the skilled person that the three stages are consecutive and preferably continuous, but that further stages may be slotted in or added either before the first stage or after the third stage, if desired.

In some embodiments the roasting process may comprise raising the temperature of the beans from around 80° C. to around 170° C. at a rate of 5 to 18° C./minute.

In some embodiments the roasting process may comprise raising the temperature of the beans from around 170° C. to around 200° C. at a rate of 5 to 15° C./minute.

The inventors have surprisingly found that heating the beans from around 80° C. to around 170° C. at a rate of 5 to 18° C./minute as well as heating the beans such that the temperature of said beans rises from a temperature of around 200° C. to at least around 230° C. at a rate of at least 25° C./minute (irrespective of the rate of heating between 170-200° C.), creates a particularly beneficial coffee product with high aroma and high phenolics (especially with diene functionality), providing a superior brew. In addition, raising the temperature of the beans from around 170 to around 200° C. at a rate of 5 to 15° C./minute further improves the subsequent brew.

In some embodiments the process may comprise removing moisture from the coffee beans to no more than 5% wt., 3% wt., 2.5% wt., 2% wt., 1.75% wt., 1.5% wt., or no more than 1% wt. during the first roasting stage, second roasting state or third roasting stage, preferably during the first roasting stage.

In some embodiments the process may further comprise an incubating or cooling step, after roasting, in which the roasted beans' temperature is lowered to between −10° C. and 40° C.

In some embodiments the incubating step may comprise contacting the roasted whole coffee beans with a cooling agent. Cooling agents may include gases, liquids or solids (such as air, water, gaseous nitrogen, liquid nitrogen, or solid CO₂, for example). Contacting the roasted whole coffee beans may comprise flushing the beans with one or more cooling agents, such as a cooled fluid (which may be a gas, liquid or solid after cooling). In some embodiments said cooled fluid may have a temperature less than 40° C., 30° C., 20° C., 10° C., or less than 8° C. In some embodiments said temperature may be less than 5° C., 2° C., 0° C., −5° C., −10° C., −30° C., −50° C., −70° C., −100° C., −130° C., or −200° C.

In some embodiments the incubating step may last for a period of time in the range of 30 to 300 minutes, particularly 60 to 240 minutes.

In some embodiments the process may comprise packing the roasted whole coffee beans through a standard packing process such as vacuum packing process or modified atmosphere ambient pressure packing process, for the production of vacuum-packed coffee bricks, coffee pouches, bags and/or tins.

### DETAILED DESCRIPTION OF THE INVENTION

In order that the invention may be more clearly understood, embodiments thereof will now be described, by way of example only, with reference to the accompanying drawings of which:

FIG. 1 illustrates a whole coffee beans temperature over time profile of conventional three stage coffee bean roasting process of the prior art;

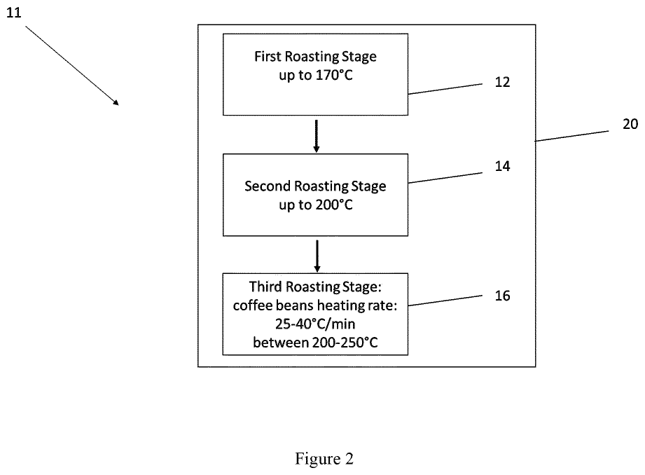

FIG. 2 illustrates a schematic flow diagram (1) of a first embodiment of a coffee beans roasting method of the first aspect of the invention;

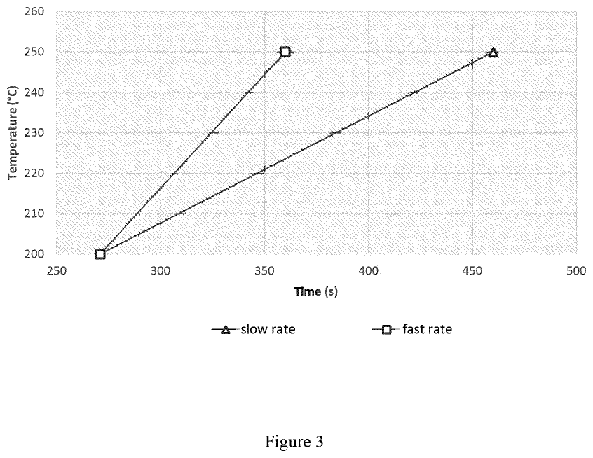

FIG. 3 illustrates the temperature over time profile for the first embodiment of the method of the invention (“fast rate”) in comparison to an embodiment of a longer time profile of the prior art (“slow rate”).

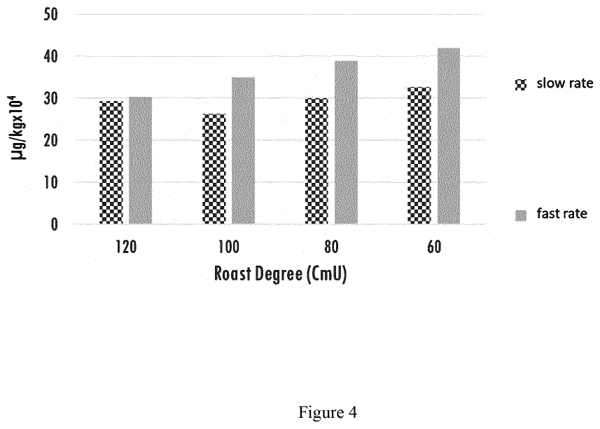

FIG. 4 illustrates the concentration of the phenolic compounds with diene functionalisation obtained from the first embodiment of the method of the invention in comparison to an embodiment of the prior art at different degrees of roasting.

FIG. 5 illustrates the concentration of the phenolic compounds without diene functionalisation obtained from the first embodiment of the method of the invention in comparison to an embodiment of the prior art at different degrees of roasting.

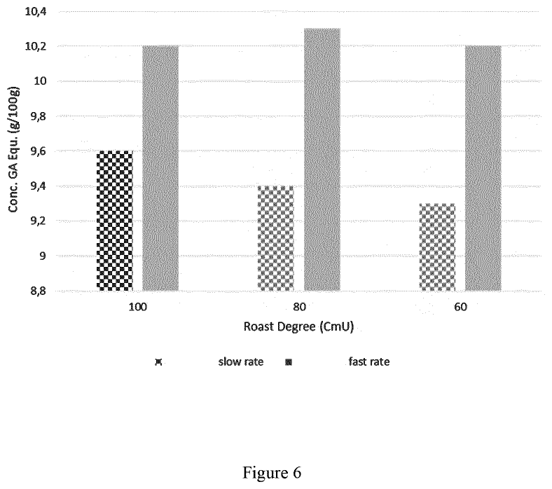

FIG. 6 illustrates the overall concentration of polyphenols obtained from the first embodiment of the method of the invention in comparison to an embodiment of the prior art at different degrees of roasting.

Referring to the Figures, like numbers represent like components.

Referring firstly to FIG. 1, a whole coffee beans temperature over time profile (1) of a three-stage roasting process of the prior art is shown.

A temperature over time profile (1) of whole coffee beans during roasting presents three roasting stages: First Roasting Stage (2) also known as drying phase, up to around 170° C., a Second Roasting Stage (4) also known as Maillard reaction and/or Strecker degradation phase starting at around 160° C. to around 170° C. and a Third Roasting Stage (6) also known as caramelisation and/or pyrolysis phase starting at around 200° C.

Unroasted whole coffee beans are loaded into a whole coffee beans roasting apparatus ready for the roasting process of the invention. The unroasted whole coffee beans are not pre-dried or pre-heated whole coffee bean, but pre-dried or pre-heated whole coffee beans are also suitable for the roasting process of the invention. The apparatus is a conventional roasting apparatus such as for instance drum roasters, paddle roasters, fluidised bed roasters, bowl roasters, rotating bowl roasters, tangential roasters, operated either in continuous or batch processing.

The temperature of the roasting apparatus is set at an initial temperature of 250° C. The unroasted or green whole coffee beans are loaded into the apparatus and are progressively heated as thermal energy is transferred from the roasting chamber and the air contained within it, to the beans. During this time, the measured temperature within the bed of beans within the roasting chamber may drop to around 80° C. as the chilled or room temperature beans absorb heat from the roaster environment. Subsequently the temperature rises over time from around 80° C. to around 170° C., around which point the whole coffee beans enter the second roasting stage.

In this stage, in existing processes the temperature of the whole coffee beans rises from between around 170 to around 200° C. at a rate of 9-18° C./minute. The coffee beans start to exhibit the characteristic aroma complexity of roasted coffee.

Finally, the whole coffee beans enter the third and final roasting stage where the whole coffee beans are heated at a rate of 15-20° C./minute to reach the final temperature of around 200° to 230° C. or higher.

Referring now to FIG. 2, a schematic flow diagram (11) of a first embodiment of a process of roasting unroasted coffee beans of the invention is represented.

The roasting process (20) is performed on whole green (unroasted) coffee beans in a conventional coffee roasting apparatus. The whole green coffee beans are heated in a First Roasting Stage (12) up to a temperature of around 170° C. The whole coffee beans are then heated up such that their temperature rises to around 200° C. through a Second Roasting Stage (14). Subsequently the whole coffee beans then enter into a Third Roasting Stage (16) where the whole coffee beans are heated at a rate of at least 25° C./min (preferably up to 60° C./min, more preferably 25-40° C./min), between around 200° C. and 230° C. and then also beyond, to the end of roast temperature.

The roasting process (20) can be carried out through conventional roasting processes, for example through a hot air roasting process and/or roasting processes using alternative gases such as for example steam water, nitrogen and/or carbon dioxide (CO₂) and/or a combination thereof in conventional appliances, for instance drum roasters, paddle roasters, fluidised bed roasters, bowl roasters, rotating bowl roasters, tangential roasters, operated either in continuous or batch processing, selecting the preferred temperature-time roasting profile suitable for the specific blend of the green coffee beans used.

After the roasting process (20) is completed the roasted whole coffee beans are sent to an incubating (or cooling) process where the temperature of the beans is manipulated (lowered) to below 40° C. and maintained as such over time, in order to improve the organoleptic characteristic of the roasted whole coffee beans.

Once the incubating process is completed the roasted whole coffee beans are then sent by means of conventional transport/transfer systems (for example pneumatic or mechanical conveying systems such as conveyor belts and infinite screws) to a packing process to be packed through a standard packing process such as, for example, vacuum packing process or modified atmosphere ambient pressure packing process, for the production of vacuum-packed coffee bricks, coffee pouches, bags and/or tins.

### Example 1

A Rotating Fluidised Bed (RFB-S) roaster (Neuhaus Neotec, Ganderkesee, Germany) was used to roast multiple batches of 400 g each of washed arabica coffee. The batches were roasted using an algorithm-based slider roasting method where the final roasting degree was measured in CmU and was set at different values, i.e., 60, 80, 100 and 120 (with a CmU tolerance ±5), where 120 CmU corresponded to a lightest roasting colour and 60 CmU corresponded to the darkest roasting. The initial temperature was set to 80° C. and the preheat temperature was set to 100° C. The time taken for the temperature to increase at a constant rate between 80° C. and 170° C. was 220 seconds for each roast. The time taken for the temperature to increase at a constant rate between 170° C. and 200° C. was 51 seconds for each roast. The fan speed was set to 40 Hz within the roasting chamber and a cooling water time of 1.7 seconds was used for each roast.

The unroasted whole coffee beans had an initial moisture content of around 10-12% by weight.

The roasting profiles (temperature over time profile) for the third roasting stage of each batch of coffee beans were set as reported in Table 1 below and as shown in FIG. 3. Samples of beans prepared according to the invention are labelled “HTST” or “fast rate” in Table 1 and FIG. 3, while samples prepared according to the prior art (i.e. slower temperature rise from 200 to at least 230° C.) are labelled “LTLT” or “slow rate”).

The end of roast temperature for each batch was set as reported in Table 1, in order to achieve the desired colour:

TABLE 1

| | |
|---|---|
| | End of Roast Temperature |
| Roast Degree | (° C.) |

| (CmU) | HTST | LTLT |
|---|---|---|
| 60 | 250 | 242 |
| 80 | 241 | 234 |
| 100 | 237 | 226 |
| 120 | 231 | 219 |

TABLE 2

| | Rate of temperature increase |
|---|---|
| | in Third Stage of roasting |
| | (from 200 to end temperature |
| Temperature/time profile | shown in Table 1) |
| “Fast rate” in Third Stage of roasting | 34° C./minute |
| (of the invention) to Roast Degree | |
| using HTST of Table 1 | |
| “Slow rate” in Third Stage of | 16° C./minute |
| roasting (prior art) to Roast Degree | |
| using LTLT of Table 1 | |

Table 2 shows the rate of heating of the beans between 200° C. and the end of roast (Third Stage) for the HTST and LTLT roast profile for each profile of Table 1. As reported in Table 2, the roasting profile of the invention corresponded to the “fast rate” profile. The “slow rate” profile was a profile of the prior art. For both profiles, the First Roasting Stage raised the temperature from around 80° C. to around 170° C., over 220 seconds, and the Second Roasting Stage raised the temperature from around 170° C. to around 200° C.over 51 seconds, before heating at the rates shown in Table 2 from 200° C. to the end of roast temperature shown in Table 1. At this point the temperature reached to the End of Roast temperature required to achieve the desired roast colour given in Table 1.

Referring now to FIG. 3, it illustrates a graphic representation of the temperature-over-time conditions reported in Table 1 for the third roasting stage of a first embodiment of the method of the invention in comparison to embodiments of the prior art.

From a starting temperature of 200° C. for both the embodiment of the invention (‘fast rate’ of Table 2) and embodiment of the prior art (‘slow rate’ of Table 2) the temperature was raised to the end of roast temperature at 34° C./minute and at 16° C./minute for the “slow rate” profile (of the prior art).

After the roasting process was completed, a sample of each batch of roasted whole coffee beans (i.e., a sample of the batch which third roasting stage was set as “fast rate” roasting profile and one of the “slow rate” third roasting stage profile of the invention for each roasting degree colour) was transferred to HPLC-PDA measurement for the determination of the concentration of phenolic compounds with (shown in FIG. 4) and without (shown in FIG. 5) diene functionalisation.

FIG. 4 represents the concentration of the phenolic compounds with diene functionalisation for the samples obtained from Example 1.

The concentration of phenolic compounds with diene functionalisation of the sample of the invention (fast rate) shows higher values than the sample of the prior art (slow rate) at each roasting degree level.

FIG. 5 represents the concentration of the phenolic compounds without diene functionalisation for the samples obtained from Example 1. For the concentration of phenolic compounds without diene functionalisation the sample of the invention (“fast rate”, HTST) with the highest roasting degree value (60 CmU) is the only one for which the difference compared to the sample of the prior art (slow rate) is significant.

After the roasting process was completed, a sample of each batch of roasted whole coffee beans (i.e., a sample of the batch which third roasting stage was set as “fast rate” roasting profile and one of the “slow rate” third roasting stage profile of the invention for each roasting degree colour) was transferred for polyphenols measurement, for the determination of the total concentration of polyphenols, as reported below.

### Analysis of Coffee for Total Polyphenols

Phenolics in each sample were measured using the following method:
1.50 g ±0.01 g sample was weight in a 20 ml headspace vial.
For extraction the following is added:
10 ml saturated salt solution to drive out the aroma compounds
10 μl Internal standard
5 ml Tertiary Butyl Methyl Ether (TBME)
The vial is capped immediately.

Subsequently all vials were placed in the shaker/incubator and extracted for 30 minutes at 40° C. After extraction the vials are centrifuged for 15 minutes at 3000 rpm, 4° C.

The vials were uncapped and an aliquot of the top layer was transferred into an amber injection vial. 1 μl of the TBME extract was injected in the GC-MS. The compounds of interest were separated by capillary gas chromatography (GC) and detected by mass spectrometry (MS) in SIM/SCAN mode. Quantification was achieved by comparing the response of the components of interest to the response of the internal standards with a known concentration. Results (as shown in FIG. 6) are expressed in μg/kg coffee.

FIG. 6 illustrates the overall concentration of polyphenols for the first embodiment of the method of the invention (fast rate, HTST) in comparison to embodiments of the prior art (slow rate, LTLT) at different degrees of roasting (60, 80 and 100 CmU of Table 1).

For each roasting degree the concentration of polyphenols of the samples of this invention (fast rate, HTST) were between 5 and 10% higher than the samples of the prior art (slow rate, LTLT), proving the ability of the method of the invention to increase/improve the concentration of anti-oxidant compounds in coffee beans roasted according to the invention and therefore their anti-oxidant activity.

The results of Example 1 therefore show that the methods of the invention provide roasted coffee beans in which the total concentration of phenolics is increased compared to prior art methods, and the total concentration of diene-functionalised phenolics is increased, at all degrees of roasting; providing roasted coffee beans which include more of the desirable antioxidants. When coupled with preferred beans heating rates from a bean temperature of 80° C. to around 170° C. (e.g., especially 5-18° C./minute) the invention provides a method which increases both aroma and antioxidant content of the resultant beans and subsequent coffee brew.

1. A process of roasting whole coffee beans comprising a roasting stage starting at a temperature of the beans of around 200° C., wherein the process comprises the step of heating said whole coffee beans such that the temperature of said beans rises from a temperature of around 200 to around 230° C. at a rate of at least around 25° C./minute.

2. A process of roasting whole coffee beans according to claim 1 wherein the step of heating said whole coffee beans from a temperature of around 200° C. to around 230° C. is at a rate of around 30° C./minute to around 60° C./minute.

3. A process of roasting whole coffee beans according to claim 1 wherein the step of heating said whole coffee beans from a temperature of around 200° C. to around 230° C. is at a rate of around 32° C./minute to around 50° C./minute.

4. A process of roasting whole coffee beans according to claim 1 wherein the step of heating said coffee beans from a temperature of around 200° C. to around 230° C. is at a rate of around 33° C./minute and around 45° C./minute.

5. A process of roasting whole coffee beans according to claim 1 wherein the process comprises the step of heating said whole coffee beans from a temperature of around 200° C. to at least around 250° C., and preferably the highest or end of roast temperature, at a rate of at least around 25° C./minute.

6. A process of roasting whole coffee beans according to claim 1 wherein the process is carried out at atmospheric pressure.

7. A process of roasting whole coffee beans according to claim 1 wherein the process comprises reducing the moisture content of the coffee beans to no more than around 5% wt. of the beans.

8. A process of roasting whole coffee beans according to claim 7 wherein the process comprises lowering the moisture content of the coffee beans to around 1 to 2% wt. of the beans.

9. A process of roasting whole coffee beans according to claim 1 wherein the process comprises raising the temperature of the beans from a temperature of around 80° C. to around 170° C., at between 5 and 18° C./minute.

10. A process of roasting whole coffee beans according to claim 1 wherein the process comprises raising the temperature of the beans from a temperature of around 170° C. to around 200° C., at between 5 to 15° C./minute.

11. A process of roasting whole coffee beans according to claim 1 wherein the process comprises an incubating step in which the final roasted beans temperature is lowered to between −10° C. and 40° C.

12. A process of roasting whole coffee beans according to claim 11 wherein the incubating step comprises contacting the roasted whole coffee beans with a cooling agent.

13. A process of roasting whole coffee beans according to claim 11 wherein the incubating step lasts for between 30 and 300 minutes.

14. A process of roasting whole coffee beans according to claim 1 wherein the process comprising packing the roasted whole coffee beans.

15. Roasted whole coffee beans obtained or obtainable according to a process of claim 1.

16. A process of roasting whole coffee beans according to claim 1 wherein the process comprises the step of heating said whole coffee beans from a temperature of around 200° C. to the highest or end of roast temperature, at a rate of at least around 25° C./minute.

17. A process of roasting whole coffee beans according to claim 1 wherein the process comprises reducing the moisture content of the coffee beans to no more than 2.5% wt. of the beans.

18. A process of roasting whole coffee beans according to claim 1 wherein the process comprises an incubating step in which the final roasted beans temperature is lowered to between −10° C. and 8° C.
